(19) United States
(12) Patent Application Publication
(10) Pub. No.: US 2025/0330556 A1
(43) Pub. Date: Oct. 23, 2025

(54) Speed camera system mounted in a mobile restroom

(71) Applicant: Michael Lance Patterson, Chevy Chase, MD (US)

(72) Inventor: Michael Lance Patterson, Chevy Chase, MD (US)

(21) Appl. No.: 18/643,664

(22) Filed: Apr. 23, 2024

(51) Int. Cl. H04N 7/18; H04N 23/51

(52) U.S. Cl. CPC H04N 7/18; H04N 23/51

(57) ABSTRACT

Fully automated and remotely monitored speed camera system housed in a modified mobile restroom. Multiple deep cycle batteries and solar charging provide long term placement to increase safety by reducing speeding within construction work zones. IoT monitoring of batteries, location, camera and lights and real time data transmission via cellular data of ticket data removes the need for an attendant. Interior ports and brackets can mount any brand of camera/strobe. Battery base and removable housing makes switching out batteries easy and by a single person.

### DETAILED DESCRIPTION OF INVENTION

A new way to house and automate speed cameras in construction zones. Enabling safer work zones and greatly reduced costs for operating cameras.

### DISCLOSURE SUMMARY

Invention title—Speed Camera System Mounted in a Mobile Restroom

Company Name—Skyline Camera Systems

Inventor—Lance Patterson mlpatterson2@verizon.net

Timeline—Inventor has been working on this system and is now filing for provisional patent Apr. 23, 2024

### BACKGROUND AND NEED

1. Speed cameras are used to capture images of vehicles exceeding speed limits. They capture the speed, time, place and tag number info. This information is normally reviewed by camera system vendor and sent to the Public Safety organization in charge of the violation area. The Public Safety organization (highway patrol, local police etc.) issues a ticket after review. This generates funds for the department and they share revenue with the camera company. Camera systems result in slower driving through the work zone and an increase in safety for the workers.
2. Currently there are two main camera systems in use, fixed speed cameras and mobile speed cameras. Mobile systems are needed for construction zones. The camera car is the current state of the art application. A vehicle is mounted with forward facing cameras and lights, or a rear facing system utilized with the rear hatch open. Staff stays with the system during its use and returns with camera car at the end of their shift to download data and change out batteries.
3. In contrast to the above-described vehicle based system, our system—using a customized mobile restroom enclosure FIG. 1 and FIG. 2—automates the process, reduces labor costs and reduces capital costs while providing a discreet and secure housing for the system. This system can be used for long duration, due to multiple batteries 3. Does not require an attendant, resulting in very low labor costs and does not require a dedicated vehicle, resulting in capital cost reduction. The IoT FIG. 3 monitoring system monitors all aspects of the system, while sending camera info directly to vendor. Each enclosure can be monitored and restarted remotely.

### DESCRIPTION

4. Invention is improvement over current speed camera systems. Reducing capital and labor costs by automating entire system, locating the cameras in a secure and discreet enclosure commonly seen at construction zones, the mobile restroom FIG. 1 and FIG. 2. Current speed cameras are vehicle mounted, require an attendant and manual data download. This system can be fully automated and with multiple batteries 3 can stay in use for a long duration. Entire system is automated with mobile monitoring of camera 1, batteries 3, data transmission, location and alerting. No vehicle is required, no attendant is required and camera data is uploaded to vender via cellular data connection 7.

### KEY ASPECTS OF SYSTEM

5. Hidden in a mobile restroom FIG. 1 and FIG. 2 provides higher ticketing rate for violators, slowing speeds and improving safety of workers. Drivers will now slow down for all mobile restrooms. Restroom height provides higher mounting for improved view of highway lanes.
6. Enclosure provides security and weather protection for system.
7. IoT monitoring system FIG. 3 (optional) fully automates process, removing cost of vehicle and staffing and provides web or mobile app info needed to monitor all enclosures.
8. Multiple batteries 3 provide long term placement of enclosure. Batteries are monitored for power, temperature etc and info is part of monitoring visuals.
9. Optional battery base FIG. 4 and trailer provide easy relocation and battery replacement.
10. Speed camera vendors mount their preferred camera system in the enclosure and directs data feed to their own portal for processing of the violations. This means they use equipment and data connections they are used to, but do not have the capital and labor costs associated with the current way of managing a speed camera installation.

### SYSTEM DETAILS

11. Enclosure is a modified mobile restroom FIG. 1 and FIG. 2, with unnecessary toilet features removed for space and weight reduction. Housing comes with standard reinforced floor or floorless to accommodate mobile battery base FIG. 4. Ports 1, 4 are offered on all sides of the enclosure to accommodate where the cameras will be mounted. Locking plugs fit into unused ports. Camera ports 1, 4 are designed to accommodate common camera and lighting equipment.
12. Enclosure can be mounted also on single trailer and also locked to another actual mobile restroom or to the concrete barrier wall. This provides security against theft, vandalism and adds to stability.
13. Battery system 3 includes reinforced base 11 in enclosure or mobile base. Mobile base features slots 13 for a pallet jack, bolts 12 for mounting the enclosure. Temperature sensors and wire harness with plug. Customer decides the number of batteries needed based on power requirements and placement duration.
14. IoT monitoring system FIG. 3 is controlled by a small, fanless industrial computer. All inputs and data are monitored and visualized. Battery levels, camera status, location and all data is sent via its cellular data connection 7. System includes battery monitor 6, computer, antenna and power switch 8 within a NEMA-rated electrical housing 2. System alerts user to any levels out of spec, low battery power, camera failure etc. Remote daily reboot for compliance with mandates regarding camera operations

### BRIEF DESCRIPTION OF DRAWINGS

FIG. 1 and FIG. 2

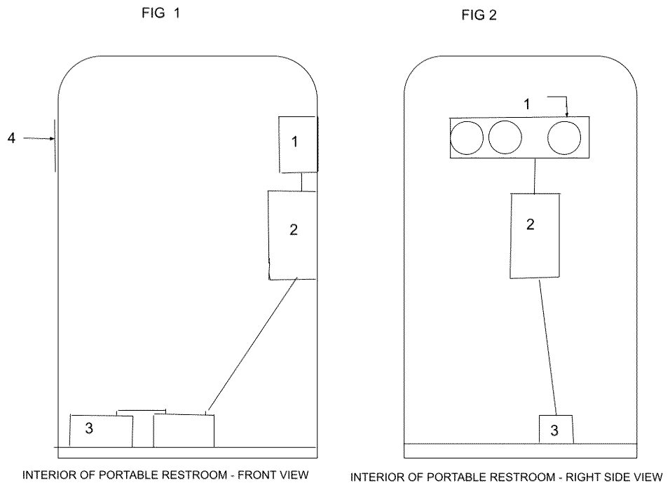

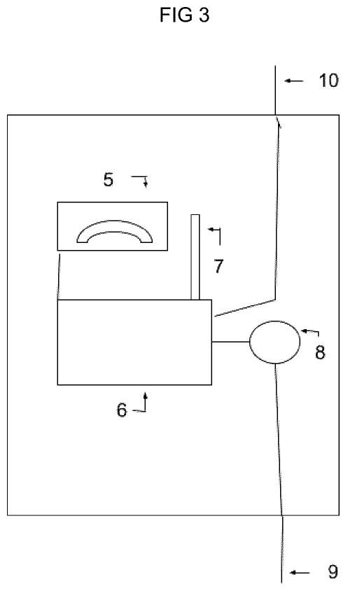

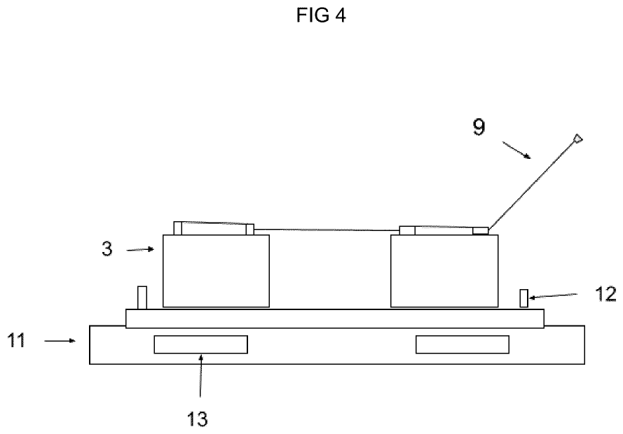

Speed camera system enclosed in a mobile restroom—interior front and right side views. The below numbers refer to specific items illustrated in FIG. 1 and FIG. 2.

Enclosure is a commercially available mobile restroom commonly seen at worksites and road construction zones. Non-essential elements of restroom (toilet, fluid storage etc.) are removed.

1—Camera and flash module housing to mount industry standard speed cameras and illumination devices.

2—Optional IoT camera and battery control unit. Enables remote restart, battery power level and camera monitoring. Cellular data connection, antenna and industrial edge computer to monitor all aspects of speed camera process.

3—Multiple 12 volt deep-cycle batteries mounted on the battery base. Reinforced battery base can be built into housing, or offered as a separate base to enable easy battery replacement by moving enclosure to a new base with charged batteries.

4—Multiple ports and plugs to provide an alternate mounting location for camera and flash.

FIG. 3

IoT (Internet of Things) control box. NEMA-rated electrical box to protect electronics from the environment. The below numbers refer to specific items illustrated in FIG. 3.

5—Active battery status monitor for multiple batteries. Power level, voltage, temperature etc.

6—Industrial edge computer with multiple input/outputs. Monitors camera and strobe status, sends pictures of speed zone violations directly to vender via cellular data connection. Takes in battery, camera, location, cell reception and security system status and sends to mobile and Web monitoring platform. Platform is a visual representation of where each enclosure is placed (map) and green, yellow or red indicators for system status. Platform sends an alert for status change to the enclosure user.

7—Cellular data antenna. Can be remote mounted to exterior roof if required for better reception.

8—12 volt power switch

9—power cable from 12-volt batteries

10—power cable to cameras and flash module

FIG. 4

Battery base. The below numbers refer to specific items in FIG. 4.

Optional battery base provides a way to quickly change out to new batteries via pallet jack or mounted on a single unit trailer. The enclosure is unbolted and moved to a new base. Old base with discharged batteries is returned to the vendor facility for recharging. System designed to make battery replacement easy and performed by a single person.

3—Multiple 12 volt deep-cycle batteries mounted on the battery base.

9—power cable from 12-volt batteries

11—Reinforced pallet-style base which supports the batteries and the portable restroom enclosure equipped with camera, flash module and related electronics

12—Fixed bolts to secure the portable restroom enclosure to the base

13—Slots to accommodate a pallet jack to facilitate moving the base with or without the portable restroom enclosure attached

1.—Highway Work Zone Speed Camera System Enclosed in a Mobile Restroom Speed cameras are the best method of encouraging correct speeds while in a highway work zone. Currently, attended vehicles with cameras mounted on the exterior are used to ticket speeders in work zones. Our claim is that speed cameras placed within a modified common portable restroom provides a unique benefit. To passing motorists, our system appears to be a ubiquitous portable restroom-the type that is seen at every highway work zone. Our enclosure disguises the speed camera system which will result in the capture of a higher number of speeding vehicles because motorists will not realize that a speed camera is present. When drivers eventually learn that any portable restroom could be a speed camera, they will reduce their speed at every highway work zone when they see a portable restroom-even when no speed camera is present. These lower speeds at virtually every highway work zone will directly enhance worker safety. Further, our system is designed so that the speed camera will operate without any human attendant and without the presence of a dedicated motor vehicle. The consequence is a significant reduction in personnel and capital expenses, which could translate into the deployment of speed camera systems at a greater number of highway work zones. The portable restroom is the perfect housing for a speed camera: secure, weather proof, adaptable to all camera systems, and with a high mounting height enabling a superior view of all highway lanes. Our system is unique and provides a service promoting construction zone safety at significantly reduced cost.

2.- IoT Remote Monitoring and Data Transmission Current camera systems come in two types: hard-wired, permanent systems, and mobile, attended cameras that require the camera data to be brought back and entered into an organization's system. Construction zone cameras are always of the mobile variety. Unlike typical mobile speed camera systems, our system is designed to stay on site for weeks (rather than hours), does not require a human attendant, sends real-time data (images and data of speeding vehicles along with battery status, system status and location data) to the operator/vendor, and is operated remotely by the vendor. The monitoring system is a NEMA-rated electrical enclosure with switching, solar charge regulator, battery smart shunts, voltage regulator, data integrator for battery shunt, and a fanless industrial computer with cellular data antenna. Our system is more efficient, costs less to operate, can remain on site to capture more speeders, and requires far less labor to operate.

3.- Battery Base Our system is designed to be placed and operated by a single person. Due to the weight of deep cycle batteries, and the fact that we can place several in a housing, we designed a battery base that has the required number of batteries, clamps, and a quick disconnect electrical harness mounted on a special base. The base uses pallet jack sized slots to enable the use of a pallet jack to easily move the batteries. Fixed bolts are utilized to attach the upper portion of the restroom enclosure to the battery base. To install fresh batteries, one person will use a pallet jack to bring a new battery base to our enclosure. They will then remove the wing nuts from the current housing, move the top portion of the restroom enclosure onto the new battery base and replace the nuts and plug in power. They will then use the pallet jack to load the old battery base into a truck and bring it back to the office for recharging. This design allows for nearly continuous operation of the speed cameras with only brief interruption to swap the old battery base for a fresh one. This design also prevents staff from lifting or carrying batteries.
